(19) United States
(12) Patent Application Publication
(10) Pub. No.: US 2008/0001914 A1
(43) Pub. Date: Jan. 3, 2008

(54) User interface for use with a business control management system

(76) Inventors: J. Michael Angle, Norcross, GA (US); Gordon C. Seeler, Lawrenceville, GA (US); Robert E. Wright, Marietta, GA (US)

Correspondence Address: MERCHANT & GOULD BELLSOUTH CORPORATION, P.O. BOX 2903, MINNEAPOLIS, MN, 55402, US

(21) Appl. No.: 11/452,496

(22) Filed: Jun. 14, 2006

(51) Int. Cl. G09G 5/00

(52) U.S. Cl. 345/156

(57) ABSTRACT

A user interface for use in managing business controls may be provided. A user may utilize the user interface to access a plurality of management tools in order to verify and manage information related to a business control. The management and verification may be used to ensure that the business control is in compliance with standard business practices. Using the user interface, the user may perform a formal signoff for one or more business controls indicating the user has reviewed the information and implemented compliance requirements associated with a standard business practice.

### BACKGROUND

A user interface for use in managing business controls is a user interface that facilitates a process for managing one or more business controls in accordance with corporate and accounting practices (business practices). In some situations, the management of such business controls requires verification that certain standards have been implemented and are current. For example, the user may desire to verify information technology (IT) controls in accordance with a certain corporate or accounting standard, for example, business record retention standards. However, the verification process may prove to be cumbersome and tedious because the process may require the use of various databases, as well as email or handwritten confirmations from designated officials attesting to the verification.

### SUMMARY

A user interface for use in managing business controls may be provided. In accordance with one embodiment, a user interface is provided for managing business controls. The user interface provides a means for presenting an interface screen to a user. The user interface provides a means for receiving user identification information to authenticate the user, and a means for verifying user permissions to view business control information. If the user is authorized to view the business control information, the user interface provides a means for accessing the business control information from a data repository and displaying the accessed business control information to the user. The user interface also provides a means for receiving formal signoff information from the user for association with the business control information, if the user is authorized to enter formal signoff information for the business control information.

In accordance with another embodiment, a business control management system is provided. The business control management system includes a memory stage and a processing unit. The processing unit of the business control management system is operative to authenticate user identification information of a user, and verify that the user is authorized to view requested business control information. If the user is authorized to view the business control information, the processing unit is also operative to permit the user to view the requested business control information. The processing unit of the business control management system is operative to provide the user with business controls management tools for use in managing a business control. Using the business controls management tools, the user can cause the processing unit to verify business control information for the associated business control and document the user provided verification using a formal signoff process.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 illustrates a networked operating environment where embodiments may be practiced;

FIG. 2 is a block diagram of a system including a computing device;

FIG. 3 is a flow chart of a method for managing business controls;

FIG. 4 is a screen shot illustrating a user interface for use with the computing device of FIG. 2; and

FIG. 5 is a screen shot further illustrating an exemplary signoff process using the user interface;

FIG. 6 is a screen shot further illustrating an exemplary signoff process using the user interface;

FIG. 7 is a screen shot further illustrating an exemplary signoff process using the user interface;

FIG. 8 is a screen shot further illustrating an exemplary signoff process using the user interface;

FIG. 9 is a screen shot further illustrating an exemplary secondary signoff process using the user interface;

FIG. 10 is a screen shot further illustrating an exemplary secondary signoff process using the user interface;

FIG. 11 is a screen shot further illustrating an exemplary secondary signoff process using the user interface; and

FIG. 12 is a screen shot further illustrating an exemplary bulk signoff process using the user interface.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A user interface for use in managing business controls may be provided. Consistent with embodiments of the present invention, a user interface, method, system, and computer readable medium for managing business controls, for example, a business control related to the Sarbanes-Oxley Act of 2002 (SOX), is disclosed. Often when managing business controls associated with corporate and accounting practices, verification of standards adherence for the business control is required in order to comply with the associated practices. However, verification of a given standard may require accessing various databases to obtain required information, capturing information acknowledging that certain standards are in place, as well as obtaining multiple levels of approval from a variety of designated officials attesting to the verification. Obtaining all the necessary information for a given business control may prove to be time consuming, inefficient and tedious. Accordingly, if the user is provided with a user interface for accessing a centralized location to verify one or more business controls as well as obtain information regarding any outstanding issues for a given business control, the user may manage the business control more efficiently.

An embodiment consistent with the invention includes a business control management system. The business control management system includes a memory stage and a processing unit. The processing unit of the business control management system authenticates user identification information of a user and verifies that the user is authorized to view requested business control information. If the user is authorized to view the business control information, the processing unit permits the user to view the requested business control information. The processing unit of the business control management system provides the user with business controls management tools for use in managing a business control. Using the business controls management tools, the user causes the processing unit to verify business control information for the associated business control and document the user provided verification using a formal signoff process.

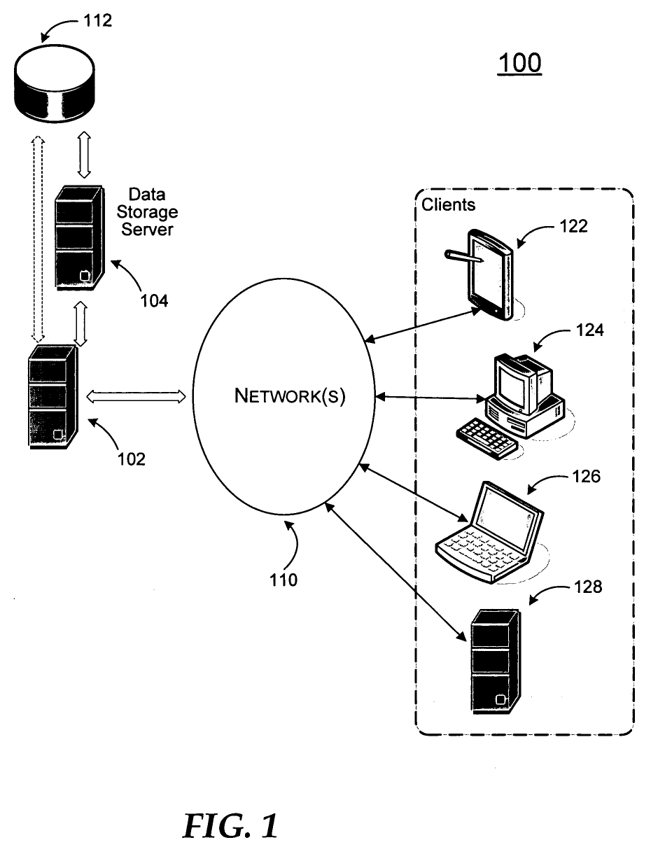

Referring to FIG. 1, a system 100 where example embodiments may be implemented is illustrated. System 100 may comprise any topology of servers, clients, Internet service providers, and communication media. Also, system 100 may have a static or dynamic topology. The term “client” may refer to a client application or a client device employed by a user to perform business logic operations. Computing devices within system 100 may use one or more programs or a server machine executing programs associated with managing one or more business controls. Both clients and application servers may be embodied as single device (or program) or a number of devices (programs). Similarly, data sources may include one or more data stores, input devices, and the like.

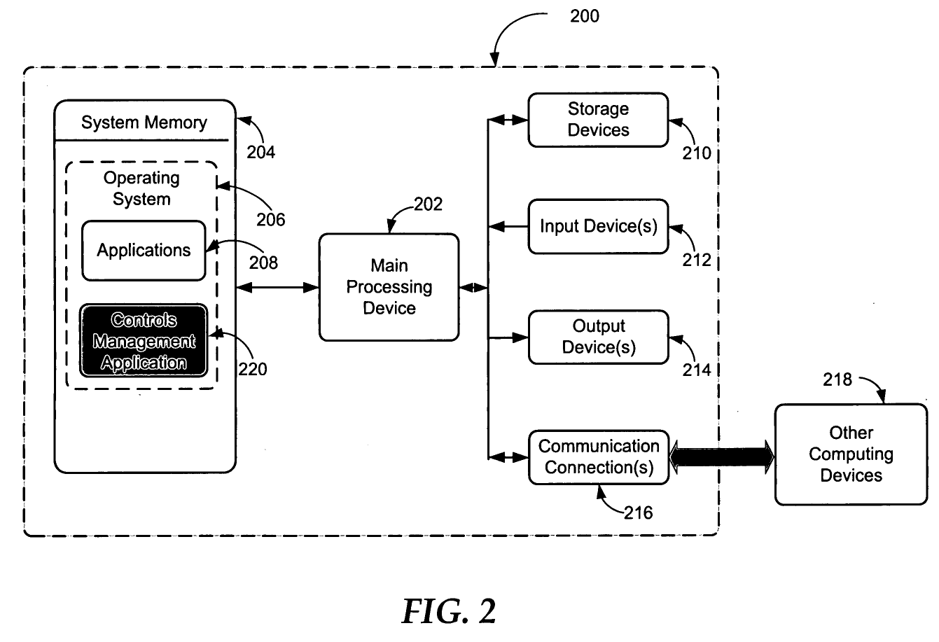

A controls management application 220, described in more detail below with reference to FIG. 2, may be run centrally on a server 102 or in a distributed manner over several servers and/or client devices. For example, server 102 may be a web server which can utilize hyper text markup language (HTML), JAVA Script, and Microsoft® AST, and the like. A number of other applications may also be configured, deployed, and shared in system 100. In addition, the controls management application may also be run in one or more client devices and information exchanged over network(s) 110.

Data store 112 is an example of a number of data stores that may be utilized to store copies of the data. Data store 112 may be managed by data storage server 104 or directly accessed by server 102 or any one of the clients. Various types of data may be created, edited and processed during the management of one or more business controls, which may be stored in data store 112. Data may include, for example, business control information, business control issues, formal signoff information for a business control, or the like.

Users may interact with server 102 by running the controls management application from client devices 122, 124, 126, and 128 over network(s) 110. In one embodiment, portions or all of the controls management application may reside on any one of the client devices 122, 124, 126, and 128. In such an embodiment, data may be stored in data store 112 without an involvement of server 102.

According to some embodiments, users may be provided one or more user interfaces (Uls) to select and define configurations associated with the management of business controls such as Sarbanes-Oxley and the like.

Network(s) 110 may include a secure network such as an enterprise network, or an unsecure network such as a wireless open network. Network(s) 110 provide communication between the nodes described above. By way of example, and not limitation, network(s) 110 may include wired media such as a wired network or direct-wired connection, and wireless media such as acoustic, RF, infrared and other wireless media.

Many other configurations of computing devices, applications, and data storage may be employed to implement a business control management system.

With reference to FIG. 2, one example system for implementing the embodiments includes a computing device, such as computing device 200. Computing device 200 typically includes a main processing unit 202 and system memory 204. The system memory 204 may be volatile (such as RAM), non-volatile (such as ROM, flash memory, etc.) or some combination of the two. System memory 204 typically provides an environment for an operating system 206 to be executed for controlling the operation of computing device 200 and execution of other programs (applications). Software applications 208 and control management application 220 are examples of programs or program modules that may be executed under the control of operating system 206 in system memory 204. Additional operating systems or programs may also be executed within system memory 204 outside the control of operating system 206. Control management application 220 enables a user to manage one or more business controls.

Control management application 220 may be an integrated part of a file management application or a separate application. Control management application 220 may communicate with other applications running on computing device 200 or on other devices. Furthermore, control management application 220 may be executed in an operating system other than operating system 206.

The computing device 200 may have additional features or functionality. For example, the computing device 200 may also include data storage devices 210 (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory 204 and storage devices 210 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 200. Any such computer storage media may be part of device 200.

Computing device 200 may also include input device(s) 212 such as a keyboard, a mouse, a pen, a voice input device, a touch input device, etc. Furthermore, output device(s) 214 such as a display, a speaker, a printer, etc. may also be included.

Communication connections 216 may be included in computing device 200 to allow the device to communicate with other computing devices 218, such as over a network in a distributed computing environment, for example, an intranet or the Internet. Communication connection 216 exemplifies various communication media. Communication media may be embodied by computer readable instructions, data structures, program modules, or other data in a modulated data signal, such as a carrier wave or other transport mechanism, and include any information delivery media.

By way of example, and not limitation, communication media may include wired media such as a wired network or direct-wired connection, and wireless media such as acoustic, RF, infrared and other wireless media. The term computer readable media as used herein refers to both storage media and communication media.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

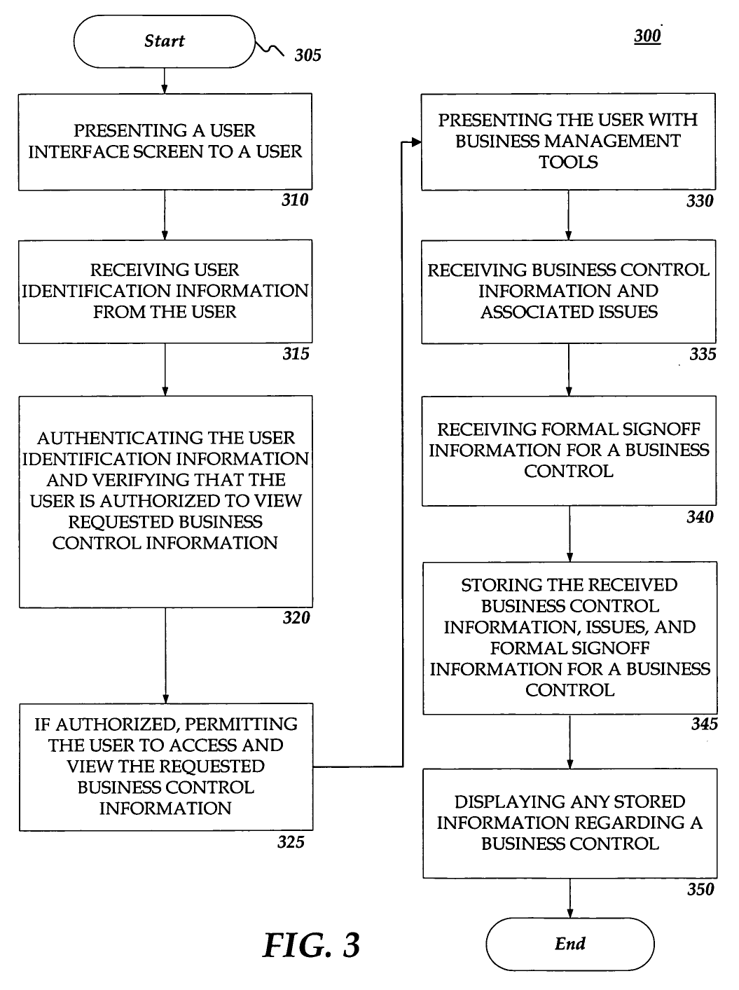

As stated above, a number of program modules and data files may be stored in system memory 204, including operating system 206. While executing on main processing unit 202, programming modules may perform processes including, for example, one or more stages of method 300 as described below with reference to FIG. 3. The aforementioned process is an example, and main processing unit 202 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

FIG. 3 is a flow chart setting forth the general stages involved in a method 300 performed by the controls management application 220 consistent with an embodiment of the invention for managing business controls using computing device 200 of FIG. 2. Ways to implement the stages of method 300 will be described in greater detail below. Method 300 begins at starting block 305 and proceeds to stage 310 where computing device 200 presents a user interface screen to a user. The user interface screen may be divided into sections having content useful to different users, for example, a network administrator, a business control owner, or a business control executive. Once the user interface is presented, the method 300 proceeds to stage 315 where the controls management application 220 receives user identification information from a user. The user identification information may include, for example, a user name and password, or any other information normally used for identifying a user. Next, at stage 320, the controls management application 220 uses the received user identification information for authenticating the user to determine if the user is authorized to access business control information for one or more business controls.

Next, at stage 325, if the user is authorized to view the business control information of one or more business controls, the controls management application 220 permits the user to access any requested business control information. If the user is an administrator, the administrator may perform administrative functions, for example, create and edit business control information, manage access to the business control information, or the like. At stage 330, the controls management application 220 presents one or more business management tools to the user. For example, the user may be presented with a business control management tool for documenting issues related to management of a server environment in use by a corporation, or a business control management tool for documenting an individual or group of individuals having supervisory control over a particular business control. If the user is not authorized to view the business control information, the user may be presented with an authorization failure screen and a request re-enter user identification information. At stage 335, the controls management application 220 receives information associated with a business control from the user.

Upon review of a particular business control, if the user determines that the business control information is correct and up to date, at stage 340, the controls management application 220 receives the user's formal signoff on the business control to signify that the business control is in compliance with specified business practices. For example, the formal signoff may signify that mainframe access controls are operating as required for a corporation to be in compliance with SOX. At stage 345, the controls management application 220 stores any business control information or formal signoff information received at stages 335 and 340 in a central location, for example, database 106. At stage 350, the controls management application 220 displays any stored information to the user.

Thus, the user is provided with a centralized location for maintaining and visualizing all information related to a business control, including issues associated with the business control, and formal signoff information. Accordingly, the user may manage business controls more efficiently.

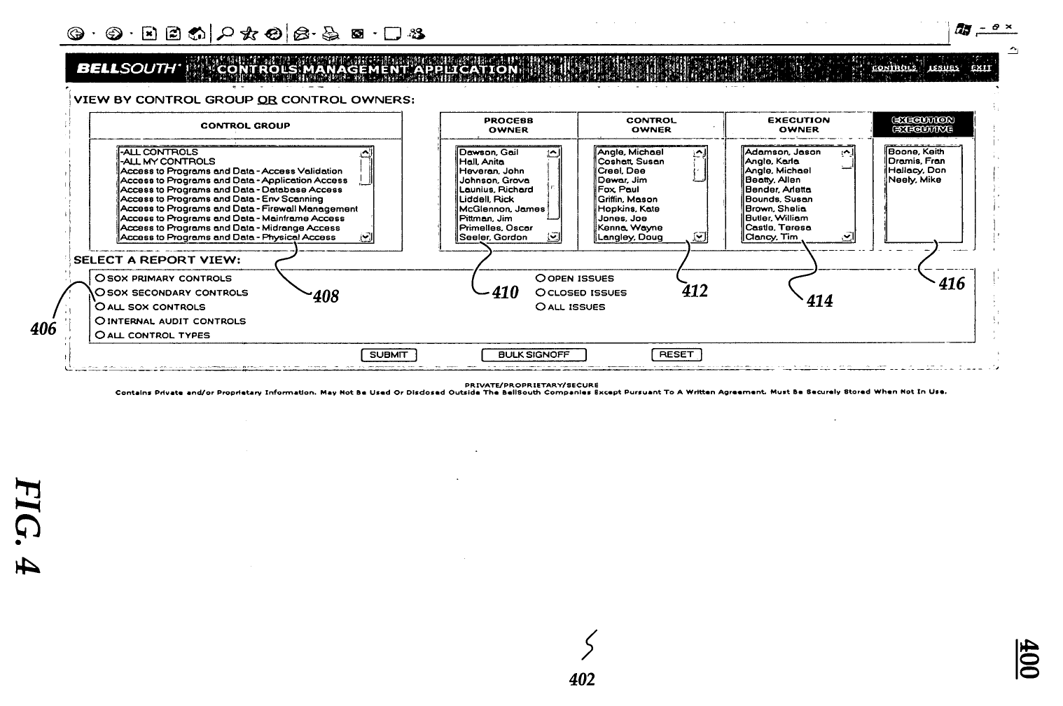

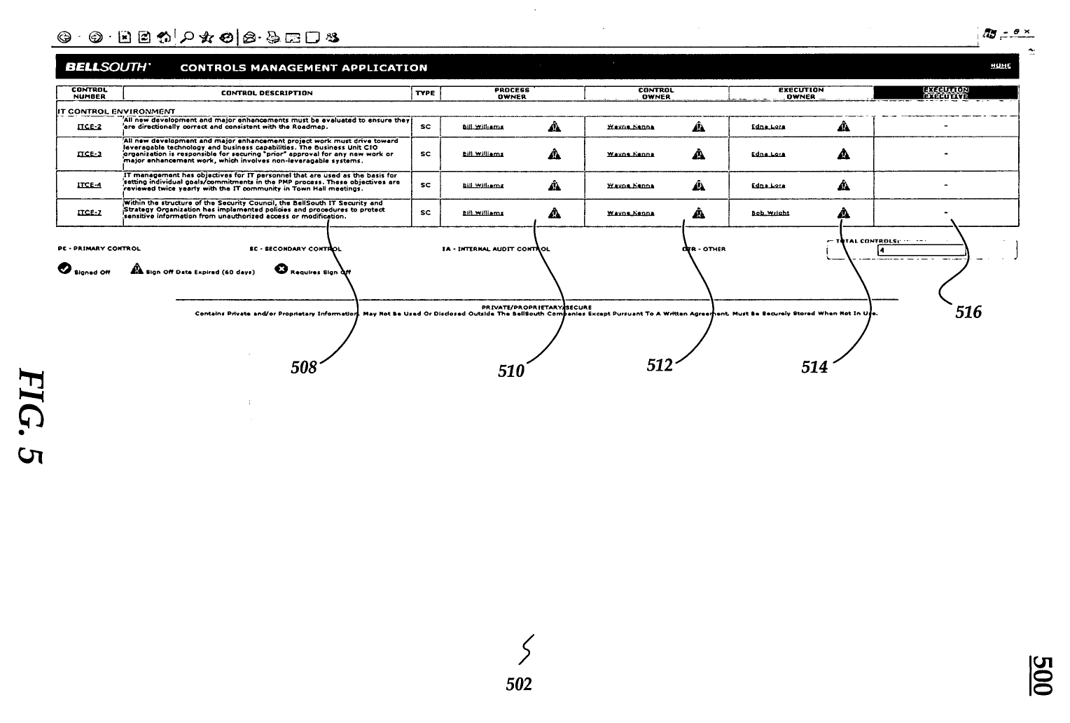

FIG. 4 illustrates an exemplary user interface 400 for use in conjunction with the controls management application 220, according to one embodiment. The user interface 400 includes a user interface screen 402. User interface screen 402 may be viewed upon successful authentication of user identification information. Within the user interface screen 402 are displayed a controls group frame 408 for selecting one or more business controls for viewing, for example, a mainframe access control (see also FIG. 5). Also, within the user interface screen 402 are one or more frames for use in, for example, a hierarchical business control management review structure. Accordingly, the user interface screen 402 may include a process owner frame 410, a control owner frame 412, an execution owner frame 414, and an execution executive frame 416. Accordingly, a user may choose a name from the appropriate frame to acquire business control information associated with the named user. In addition, the user interface screen 402 provides a reporting section 406 for selecting one or more reports based on desired business control information and open issues related to a business control.

FIG. 5 illustrates an exemplary user interface 500 for use in conjunction with the controls management application 220, according to one embodiment. The user interface 500 provides a user interface screen 502 which may be viewed upon the selection of a business control from business controls group frame 408, or the selection of a designated user under process owner frame 410, control owner frame 412, execution owner frame 414, and execution executive frame 416. For example, the user may view IT control environment information by selecting an appropriate link in the business controls group frame 408 (FIG. 4). Accordingly, the user may view associated business control information and information related to management for the business control. For example, if the user is unfamiliar with a particular business control, the user may review a control description section 508 to obtain more information about the business control. In addition, under a hierarchy structure, the user may view the various levels of management responsible for managing an associated business control, see sections 510, 512, 514 and 516.

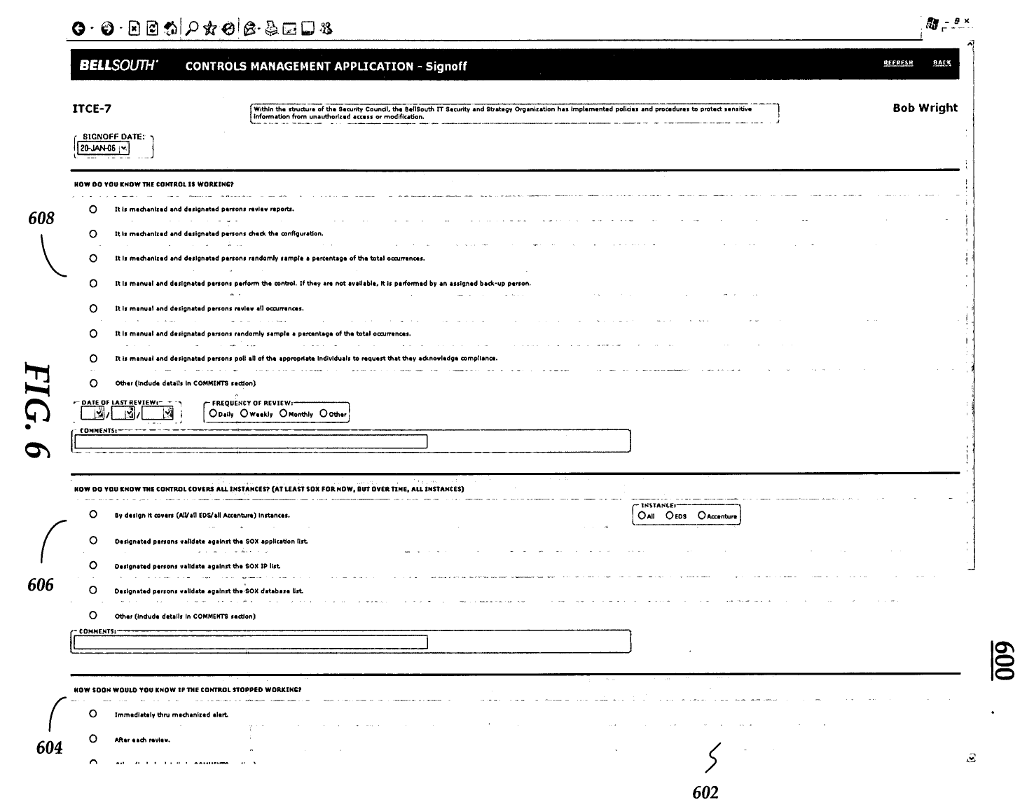

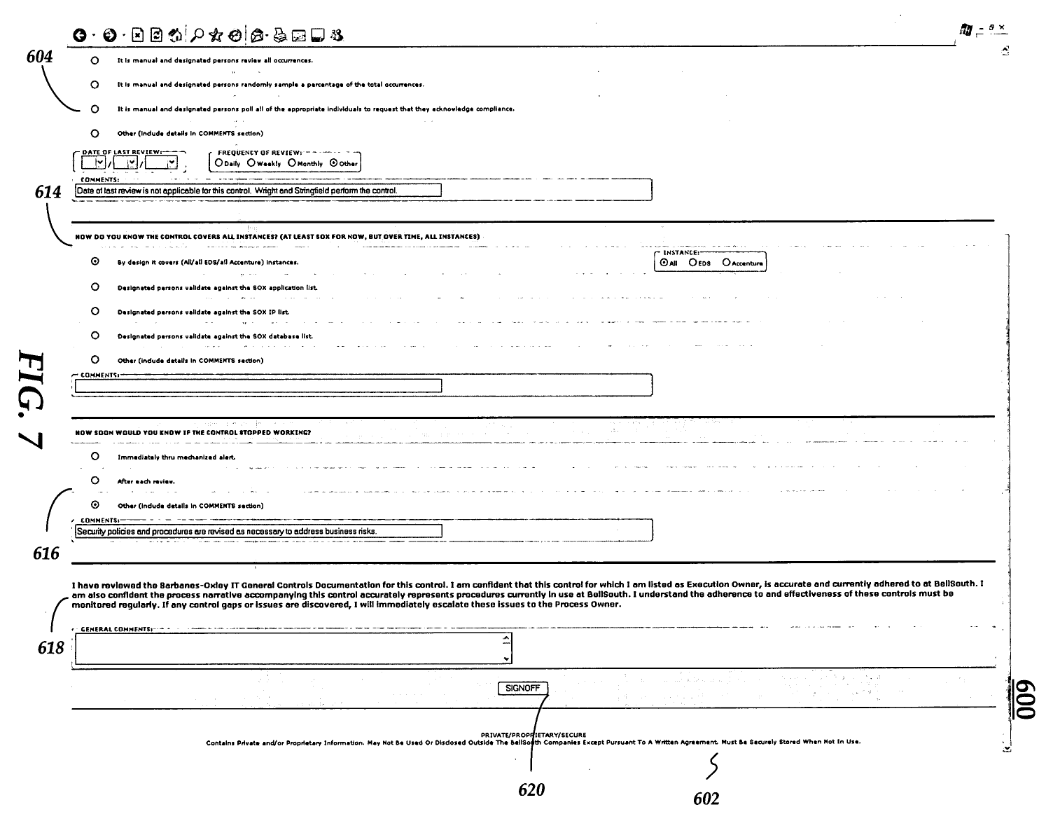

FIGS. 6 and 7 illustrate an exemplary user interface 600 for use in conjunction with the controls management application 220, according to one embodiment. The user interface 600 provides a user interface screen 602 which may be viewed upon the selection of a name associated with a particular business control, see sections 510, 512, 514 and 516. The user interface screen 602 lists one or more sections containing attributes for association with a particular business control, see 604, 606, 608, 614 and 616. In each section, the user may select an appropriate response to a question related to the particular business control, as well as provide information regarding business control review frequency and comments. In addition, in section 618, if the user is authorized to signoff on a particular business control, for example, the user is listed in sections 510, 512, 514, or 516; the user may be presented with a comments section and an opportunity to formally signoff on the particular business control using the signoff button 620.

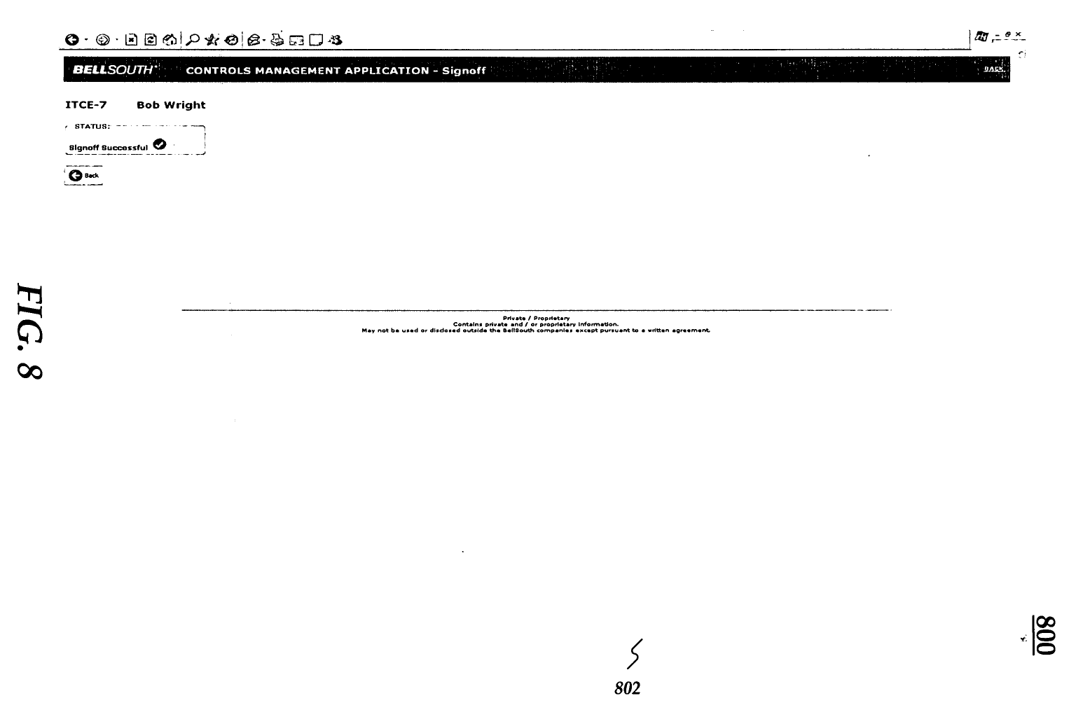

FIG. 8 illustrates an exemplary user interface 800 for use in conjunction with the computing device 200, according to one embodiment. The user interface 800 provides a signoff confirmation screen 802 which may be viewed upon using the signoff control button 620. Accordingly, the user may verify that business control information and signoff information input by the user in FIGS. 6 and 7 are stored in a centralized location, for example database 106.

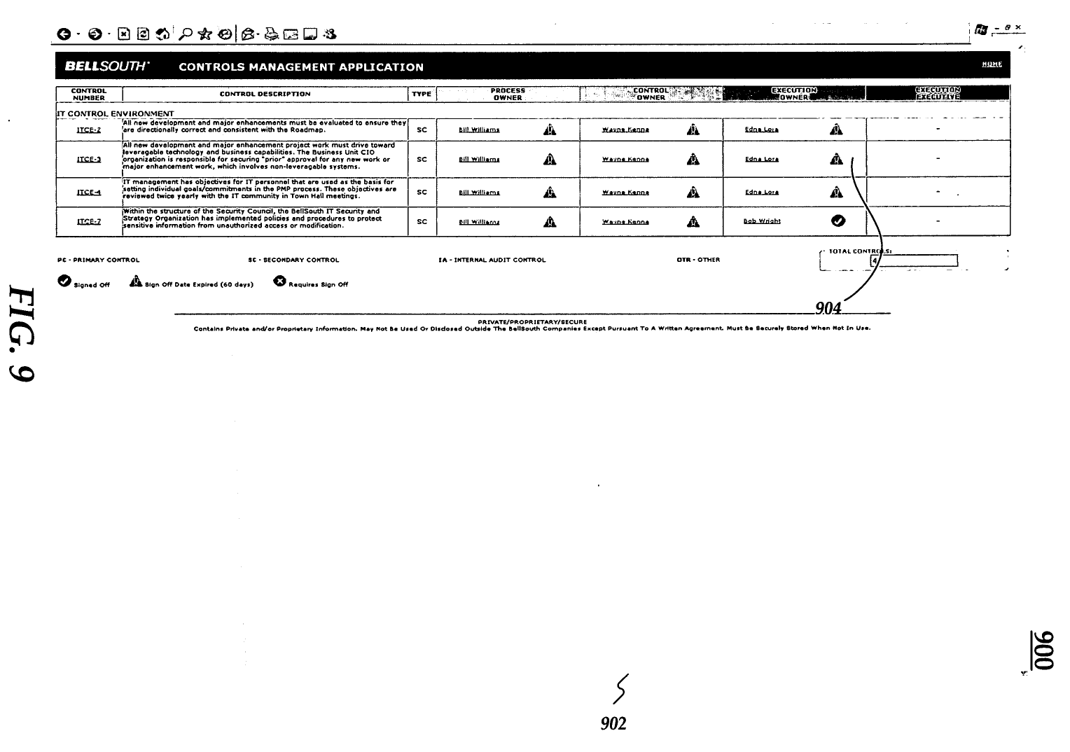

FIG. 9 illustrates an exemplary user interface 900 for use in conjunction with the controls management application 220, according to one embodiment. The user interface 900 provides a user interface screen 902 which may be viewed upon the selection of a business control from the business controls group frame 408, or the selection of a designated user under process owner frame 510, control owner frame 512, execution owner frame 904, and execution executive frame 516. Accordingly, an execution owner frame 904 indicates that an execution owner managing a business control ITCE-7 has formally signed off thereby verifying that the execution owner has completed any assigned compliance requirements associated with business control ITCE-7.

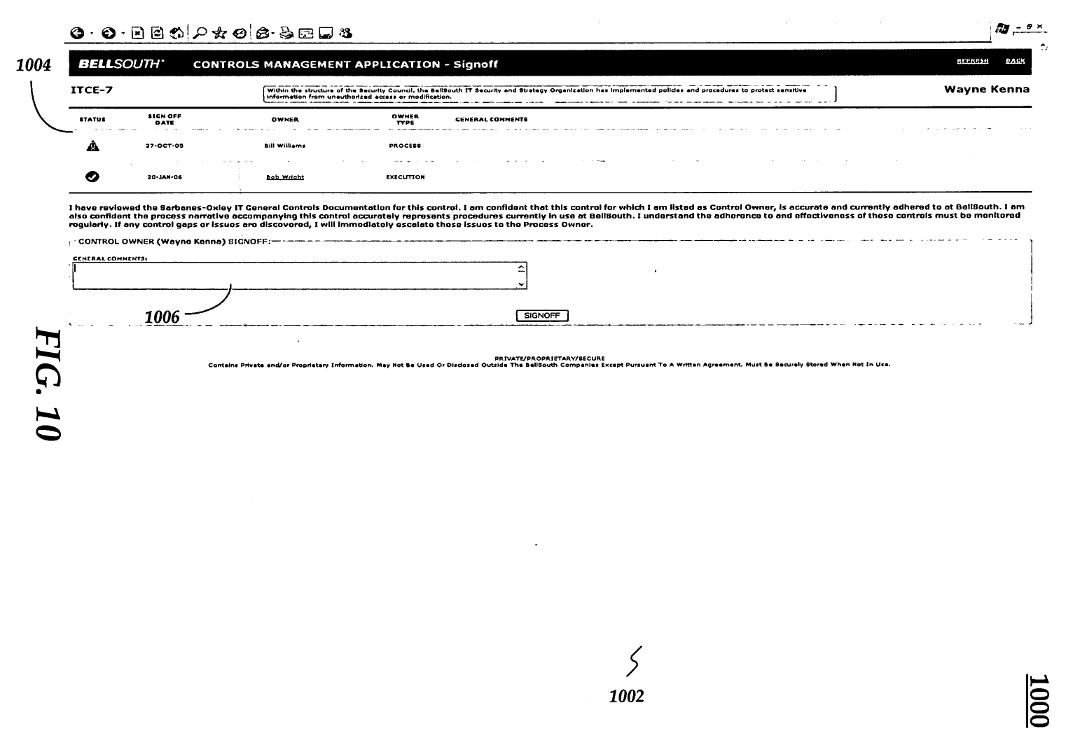

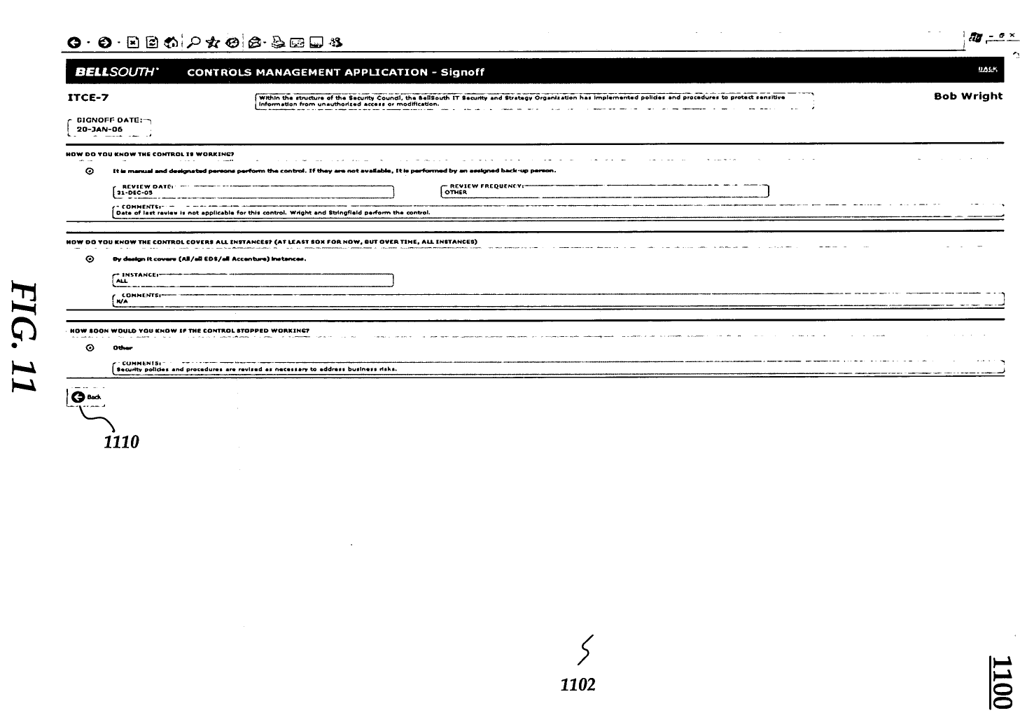

FIG. 10 illustrates an exemplary user interface 1000 for use in conjunction with the controls management application 220, according to one embodiment. The user interface 1000 provides a user interface screen 1002 which may be viewed upon the selection of a name associated with a supervisory level of management responsible for managing a particular business control, see sections 510, 512, 514 and 516. Accordingly, the control owner 512 for the business control ITCE-7 may review the formal signoff information of the execution owner 514 by, for example, selecting a link associated with the execution owner 514. The control owner 512 may then view user interface screen 1102 shown in FIG. 11, to ensure that certain compliance procedures have been completed by the execution owner 514, and the date of completion. Upon such a review, the control owner 512 may select a Back button 1110 to return to user interface screen 1002. If satisfied with the information supplied by the execution owner 514 and after completing assigned compliance procedures, the control owner 512 may formally sign off on the business control thereby verifying that the control owner 512 has completed any assigned compliance procedures associated with business control ITCE-7.

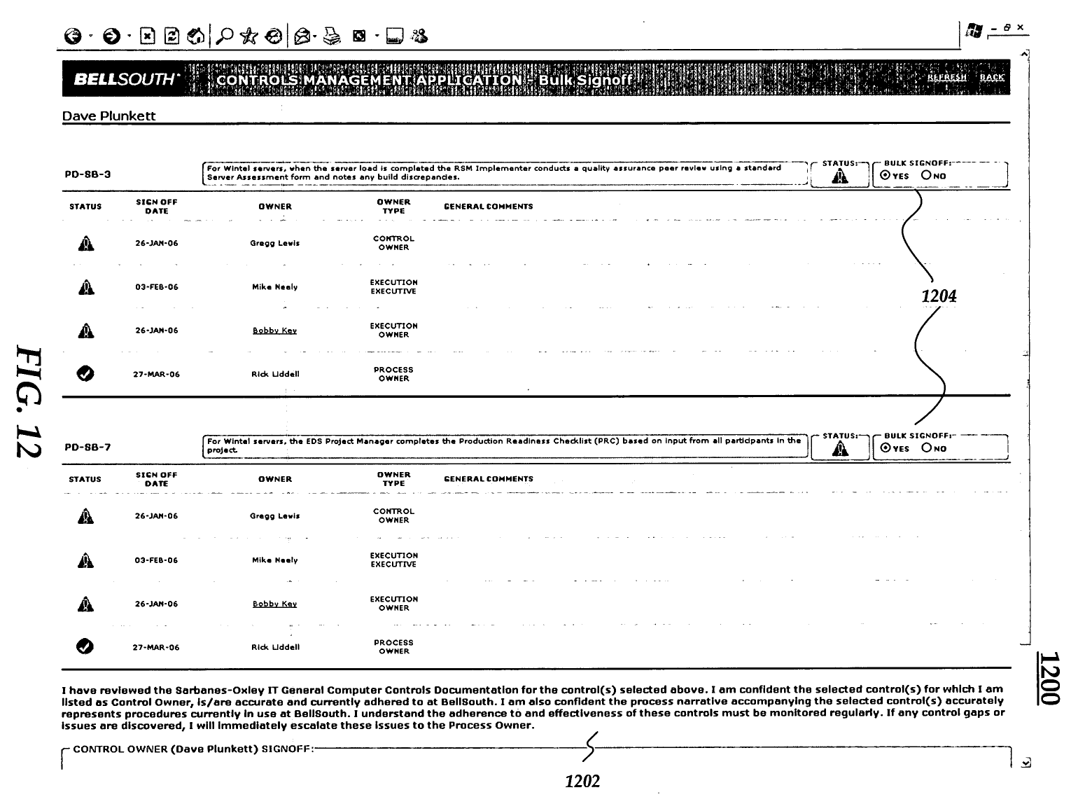

FIG. 12 illustrates an exemplary user interface 1200 for use in conjunction with the controls management application 220, according to one embodiment. The user interface 1200 provides a user interface screen 1202 which may be viewed upon the selection of a name within process owner frame 410, control owner frame 412, execution owner frame 414, and execution executive frame 416. Upon selection of a name, all business controls assigned to an individual may be viewed. If more than one business control is assigned to the individual, the individual may formally signoff on the one or more business controls if compliance procedures have been completed for the selected business controls, such as bulk signoff 1204. If the designated user is associated with a supervisory level of management for a business control, the user may review formal signoff information from subordinates to ensure compliance with corporate and accounting procedures prior to performing a bulk signoff.

Consistent with embodiments of the present invention, a system and user interface for use in managing business controls may be provided for managing and maintaining business control information relating to compliance, issues, signoffs, ownership, or the like, in a central location. The system and user interface may be used in managing documentation related to Sarbanes-Oxley, finance or any other subject matter requiring maintenance of documentation. Consistent with embodiments of the present invention, the controls management application 220 may reside in the computing device 200, a server connected to computing device 200, or both the computing device 200 and server connected to computing device 200.

What is claimed is:

1. A user interface for use in managing business control information, the user interface comprising:
means for presenting an interface screen to a user;
means for receiving user identification information for authenticating the user to verify that the user is authorized to view requested business control information for an associated business control;
if the user is authorized, means for accessing the business control information from a data repository;
means for displaying the accessed business control information to the user; and
means for receiving formal signoff information for association with the business control information, if the user is authorized to enter formal signoff information for the associated business control.

2. The user interface of claim 1, wherein the interface screen is partitioned for receiving user identification information from the user and receiving administrator identification information from an administrator.

3. The user interface of claim 1 further comprising means for accessing and displaying the business control information over a secure network.

4. The user interface of claim 1, further comprising means for receiving input from the user to display user designated business control information.

5. The user interface of claim 4, wherein the user can select at least one business control from a plurality of business controls for displaying the associated business control information.

6. The user interface of claim 1 further comprising means for linking one or more issues to the business control information.

7. The user interface of claim 6 further comprising means for displaying the one or more issues upon selection of the link.

8. The user interface of claim 1 further comprising means for receiving bulk formal signoff information for association with a plurality of business controls, wherein the user is authorized to enter formal signoff information for each business control in the plurality of business controls.

9. The user interface of claim 1, wherein a plurality of users can enter formal signoff information for a business control.

10. The user interface of claim 9, wherein a hierarchy for entering formal signoff information is applied to the plurality of users.

11. The user interface of claim 10, wherein a first user is not permitted to enter formal signoff information until a second user being subordinate to the first user enters formal signoff information.

12. The user interface of claim 1, wherein the business control information is associated with Sarbanes-Oxley compliance.

13. A system for managing business control information, the system comprising:
a memory storage;
a processing unit coupled to the memory storage, wherein the processing unit is operative to:
authenticate user identification information for a user to verify that the user is authorized to view requested business control information for an associated business control;
if the user is authorized to view the requested business control information, present the requested business control information to the user;
provide business control management tools for managing the business control information, wherein the business control management tools are used to verify compliance with associated business practices; and
if the business control is assigned to the user, allow the user to perform a formal signoff; and
a display device for displaying the business control information.

14. The system of claim 13 further comprising a web server for providing an interface screen over a network.

15. The system of claim 14, wherein the web server uses any one of the following: Hyper Text Markup Language, Java Script, and Microsoft AST.

16. The system of claim 13 further comprising a database for storing any one of the following: business control information, user authentication information, user verification information, one or more business controls, one or more issues associated with one or more business controls, links for associating the one or more issues with the one or more business controls, formal signoff information, bulk formal signoff information, and business control ownership information.

17. The system of claim 13, wherein the processing unit is associated with a server.

18. The system of claim 13, wherein the processing unit is associated with a client-side device.

19. The system of claim 13, wherein the business control information is associated with Sarbanes-Oxley compliance.

20. A method for using a user interface to manage business control information, the method comprising:
presenting an interface screen to a user;
receiving user identification information for authenticating the user to verify that the user is authorized to view requested business control information for an associated business control;
if the user is authorized, accessing the business control information from a data repository;
displaying the accessed business control information to the user; and
receiving formal signoff information for association with the business control information, if the user is authorized to enter formal signoff information for the associated business control.
